(19) United States
(12) Patent Application Publication
(10) Pub. No.: US 2021/0053120 A1
(43) Pub. Date: Feb. 25, 2021

(54) Method for Manufacturing a Contact Component, and Contact Component, Vacuum Interrupter and a Switchgear

(71) Applicant: Siemens Aktiengesellschaft, München (DE)

(72) Inventors: Ursus Krüger, Berlin (DE); Oliver Stier, Berlin (DE)

(73) Assignee: Siemens Aktiengesellschaft, München (DE)

(21) Appl. No.: 16/964,698

(22) PCT Filed: Dec. 20, 2018
(86) PCT No.: PCT/EP2018/086324

§ 371 Date: Jul. 24, 2020

(30) Foreign Application Priority Data
Jan. 29, 2018 (DE) 10 2018 201 301.2

(51) Int. Cl. B22F 3/105; B29C 64/153; B22F 7/02; H01H 11/04; H01H 1/023; H01H 1/025

(52) U.S. Cl. CPC B22F 3/1055; B29C 64/153; H01H 1/025; H01H 11/048; H01H 1/023; B22F 7/02

(57) ABSTRACT

Various embodiments include a method for manufacturing a contact component for an electrical switch with a contact surface for closing in electrical contact comprising manufacturing the contact component at least partially using a powder. At least two powder types are used to create different material compositions in the contact component. Manufacturing the contact component include using an additive fabrication process based on a powder bed. The contact component includes a sequence of layers. At least two of the layers include different powder types.

### CROSS-REFERENCE TO RELATED APPLICATIONS

This application is a U.S. National Stage Application of International Application No. PCT/EP2018/086324 filed Dec. 20, 2018, which designates the United States of America, and claims priority to DE Application No. 10 2018 201 301.2 filed Jan. 29, 2018, the contents of which are hereby incorporated by reference in their entirety.

### TECHNICAL FIELD

The present disclosure relates to electrical contacts. Various embodiments of the teachings herein may include methods for manufacturing a contact component for an electrical switch with a contact surface for closing an electrical contact, contact components, vacuum interrupters with a contact component, and/or switchgears with a vacuum interrupter.

### BACKGROUND

Electrical switches are described, for example, in DE 41 33 466 A1. These switches comprise contact components, wherein their function is to come into mutual contact during a switching process in order to convey the electrical current. The contact components are positioned with respect to one another in the switch in a mechanical arrangement that allows it to perform the switching process. Such switches can inter alia also be implemented as vacuum interrupters. Electrical switches are installed in switchgears that permit the integration of the switch into, for example, an electrical grid.

DE 41 33 466 A1 describes how contact components for a switch can be coated with a contact layer. This can, for example, consist of silver and be applied electrochemically. During the electrochemical coating, graphite particles are also incorporated into the layer as it forms. The graphite particles are added to the electrolyte used for the electrochemical coating, so that a dispersion results. This allows the graphite particles to be incorporated during the electrochemical coating.

Contact components can also be manufactured in a powder-metallurgical manner, as is described in EP 2 838 096 A1. Different powders can be used here, and combined, layer-by-layer, into a sintered body. The sintering can, for example, take place using what is known as spark plasma sintering (SPS). Through the use of different powder types in which there are powder particles of different powder types, graphite particles can, for example, be embedded in a matrix of silver. The sintering method requires the manufacture of suitable tools for pressing the contact component, while the sintering treatment for compressing the particles requires a certain treatment time.

Graduated layers can also be manufactured with the said method, in which the material composition in the contact component changes continuously or at least in small steps. To this end, the contact component is constructed in multiple layers, wherein a plurality of powder types with material compositions that change in steps must be kept ready. According to V. I. Mali et al., Structure and Properties of Explosively Compacted Copper-Molybdenum, Combustion, Explosion, and Shockwaves, Vol. 38, No. 4, pp. 473-4T1, 2002, contacts can also be manufactured in that a mixture of powders is applied to a substrate by means of explosive cladding. The substrate can, for example, be a contact body.

### SUMMARY

The teachings of the present disclosure include methods for the manufacture of contact components with zones of different material composition which, with a small effort in terms of stocking materials, ensures a comparatively broad leeway for a modification of concentration ratios of these materials in the contact component. Various embodiments of the teachings herein may include contact components for an electrical switchgear, vacuum interrupters with such a contact component, and/or switchgears with such a contact component, wherein a comparatively broad leeway for a local modification of the composition can be exploited.

For example, some embodiments include a method for manufacturing a contact component (15a, 15b) for an electrical switch with a contact surface (126) for closing in electrical contact, wherein the contact component (15a, 15b) is at least partially manufactured from powder and different powder types are used for the fabrication of different material compositions in the contact component (15a, 15b), characterized in that an additive fabrication process based on a powder bed is used, in which the contact component (15a, 15b) is at least partially manufactured in a sequence of layers in a powder bed (13), and powders (19a, 19b, 19c) of different powder types are combined in at least a part of the layers to manufacture different material compositions.

In some embodiments, the powders (19a, 19b, 19c) of different powder types are combined in that they are applied by a plurality of dosing devices (20a, 20b, 20c) in at least one of the layers of the powder bed (13) that are to be produced.

In some embodiments, at least one of the dosing devices is implemented as a sprinkling device (20c) and is guided at a distance above the surface of the powder bed (13), while the powder (19c) of a first powder type is dosed through sprinkling.

In some embodiments, after the dosing by sprinkling, the surface of the powder bed (13) is smoothed with a further dosing device, in particular a wiper (20a) or a roller (20b).

In some embodiments, after the dosing with powder (19c) of the first powder type, powder (19a) of a second powder type is dosed by the further dosing device, in particular the wiper (20a) or the roller (20b) in that the powder (19a) of the second powder type is pushed from a powder store (21) onto the powder bed (13) with the wiper (20a) or the roller (20b).

In some embodiments, the powder (19a, 19b, 19c) is only dosed in a partial area of the powder bed (13) by at least one of the dosing devices (20a, 20b, 20c).

In some embodiments, the powder (19c) of a first powder type is dosed into a partial area of the layer of the powder bed (13) that is to be manufactured, after which at least a part of the powder (19c) of the first powder type is solidified by an energy source, and powder of a second powder type (19a) is then dosed into the same layer, and at least a part of the powder (19c) of the second powder type is solidified by an energy source.

In some embodiments, the powder (19c) of the first powder type contains chromium, nickel, tungsten, iron, tantalum, niobium, molybdenum, rhenium, titanium, zinc, carbon, SnO2, WC, CdO, ZnO, Fe2O3, ZrO2, MgO, NiO or In2O3, and the powder of the second powder type contains silver or copper.

In some embodiments, an inset structure (30) is created from the powder (19c) of the first powder type in a plurality of sequential layers, and is embedded in the powder (19a) of the second powder type when it is solidified.

In some embodiments, a powder mixture is created in the layer of the powder bed (13) from powder (19c) of a first powder type and from powder (19a) of a second powder type.

In some embodiments, the powder (19c) of the first powder type contains chromium, nickel, tungsten, iron, tantalum, niobium, molybdenum, rhenium, titanium, zinc, carbon, SnO2, WC, CdO, ZnO, Fe2O3, ZrO2, MgO, NiO or In2O3 and the powder (19a) of the second powder type contains silver or copper or a mixture of particles of silver or copper and particles of one of the materials chromium, nickel, tungsten, iron, tantalum, niobium, molybdenum, rhenium, titanium, zinc, carbon, SnO2, WC, CdO, ZnO, Fe2O3, ZrO2, MgO, NiO or In2O3.

In some embodiments, the mixing ratio between the powder (19c) of the first powder type and the powder (19a) of the second powder type is changed in the sequence of the layers.

In some embodiments, the contact component (15a, 15b) is manufactured through the additive creation of a contact layer (130) on a prefabricated contact carrier (123, 124).

In some embodiments, it is manufactured by a method as described herein.

As another example, some embodiments include a vacuum interrupter, characterized in that it comprises a contact component (15a, 15b) as described herein.

As another example, some embodiments include a switchgear, characterized in that it is installed in a vacuum interrupter as described herein.

### BRIEF DESCRIPTION OF THE DRAWINGS

Further details of the teachings herein are described below with reference to the drawings. Identical or mutually corresponding drawing elements are each given the same reference signs, and are only explained multiple times when there are differences between the individual figures. In the figures:

FIG. 1 shows a sectional view of an exemplary embodiment of a method incorporating teachings of the present disclosure in which selective laser melting is employed,

FIG. 2 shows a three-dimensional view of an exemplary embodiment of a method incorporating teachings of the present disclosure in which the powder is dosed by sprinkling,

FIG. 3 shows a sectional view of a vacuum interrupter in which two exemplary embodiments of the contact component are used,

FIG. 4 shows an exemplary embodiment for the contact head of a vacuum interrupter as another exemplary embodiment of a contact component incorporating teachings of the present disclosure, and

FIG. 5 shows a partially cutaway side view of a contact platelet with a contact layer as a further exemplary embodiment of a contact component incorporating teachings of the present disclosure, wherein this contact platelet can be used in a vacuum interrupter according to FIG. 3.

### DETAILED DESCRIPTION

Various embodiments of the teachings herein include the manufacture of a contact component, in that an additive fabrication method based on a powder bed is employed, wherein the component is manufactured in a powder bed in a sequence of layers. In some embodiments, different powder types are combined in at least a part of the layers to create the zones of different material composition or a continuously changing material composition. In some embodiments, different material compositions are created in the individual layers through different combinations of the powder types that are available. In this way it is possible to arrange the powder types (i.e. the powders of different powder types) are combined with one another during the creation of the layer in the powder bed so that their mixing ratio determines the material composition during the manufacture of the contact component. Only a small number of different powder types need to be stored, since it is not necessary to keep powder types with different mixing ratios of their components ready separately in stock.

Selective laser sintering (also known as SLS), selective laser melting (also known as SLM), and electron-beam melting (also known as EBM) are examples of additive fabrication. These methods are suitable for processing metal materials in the form of powders with which construction components can be manufactured. In SLM, SLS and EBM the components are fabricated in layers, typically in a powder bed. These methods are therefore also referred to as powder-bed-based additive fabrication methods. One layer of the powder is generated at a time in the powder bed and is then locally melted or sintered by the energy source (laser or electron-beam) locally in those regions in which the component should be formed. The component is thus generated in successive layers and can be removed from the powder bed after fabrication. It is characteristic for SLS that in this method the powder particles are not completely fused. In contrast, the quantity of energy input in SLM and EBM is deliberately made sufficiently high for the powder particles to be completely fused.

In some embodiments, the different powder types are combined in at least a part of the layers in such a way that powder of a first powder type is dosed in a partial area of the layer of the powder bed to be fabricated, then at least a part of the powder of the first powder type is solidified by an energy source, after which powder of a second powder type is dosed into the same layer and at least a part of the powder of the second powder type is then solidified by the energy source, wherein the two solidified powder types (i.e. the two powders of the two powder types) together form the manufactured layer of the contact component. In this way it can be arranged that in the contact component the powder of the first powder type is solidified in the created layer without mixing with a different powder type.

In some embodiments, an inset structure is generated in multiple successive layers in the contact component. This can improve the functionality of the contact component. Inset structures can, for example, be formed in such a way that they influence the structure of the magnetic field during the switching process, and in this way also affect the propagation of the arc that forms. For this purpose, in conventional switch contacts in which contact layers for electrical contacting are applied to contact heads, slots are introduced into these contact heads which can be at least partially filled with a material as an inset structure in the contact component that has been additively manufactured according to the invention. This material does not conduct the current as well as the surrounding material of the contact component. The slots, or the inset structures, can run at an angle to the plane of the contact surface. In addition, the slots or the insets in the plane of the contact surface and in planes parallel to the contact surface can run helically to the outside.

In some embodiments, a method include changing the mixing ratio between the powder of the first powder type and the powder of the second powder type in the sequence of layers. The ratio of the powder types applied by the dosing device in neighboring layers can be changed for this purpose. If the mixing ratio is changed in each new layer, a concentration gradient of the powder of the first powder type in the powder of the second powder type (and vice versa) develops. The mixing ratio of a plurality of neighboring layers can, however, also be retained, so that concentration jumps between two groups of generated powder layers can be realized.

In some embodiments, the different powder types are combined in that they are introduced by a plurality of dosing devices in at least one of the layers of the powder bed to be generated. A dedicated dosing device can thus be provided for each powder type, so that a change of dosing devices is not necessary. In order to realize a mixture of powder types, or a local creation of inset structures, whichever dosing device contains the powder type concerned is actuated. In this way a change between the powder types is advantageously possible without additional fitting times.

In some embodiments, at least one of the dosing devices is guided at a distance above the surface of the powder bed, and the powder is dosed by sprinkling. In this way it is possible for the powder of a first powder type to be dosed by means of a wiper, in that the material is pushed over the powder bed. The powder of a second powder type can be distributed by means of the further dosing device onto this material through sprinkling. This is particularly advantageous when the powder of the second powder type should only have a low concentration.

If inset structures are to be manufactured, the dosing for the material (powder of the second type) surrounding the inset structure by sprinkling additionally has the advantage that the powder of the second type can also be reliably dosed in the immediate surrounding of the inset structure. This would be different were a wiper used, since a dosing of powder immediately behind the inset structure (as seen in the direction in which the wiper moves) is only possible with a reduced quantity (known as shadow formation). A special embodiment of the invention thereby arises, in that both the powder of the first type as well as the powder of the second type are dosed with a sprinkling device (dosing device for sprinkling).

In the last-mentioned case, the dosing device for sprinkling must be implemented in such a way that a local dosing of powder of the first powder type and of the second powder type in the powder bed is possible. A dosing hopper can, for example, be used for this purpose. If the powder of the second powder type is to be distributed over a larger surface area, then a slot-shaped dosing device that is guided horizontally over the powder bed while the powder of the second powder type is sprinkled out of it is appropriate.

In some embodiments, different methods can be applied for mixing the particles in the layers of the powder bed. If a dosing device for sprinkling is used, a local dosing can advantageously for example only take place where the layer of the powder bed is to be solidified to the component. As a result, powder material that is not solidified is only contaminated to a low extent by the added component, which simplifies reuse. The surface of the powder bed can be smoothed after the dosing by sprinkling by means of a smoothing device such as a wiper or roller, in order to encourage a homogeneous distribution of the dosed powder.

After the dosing by powder of a first powder type through sprinkling, powder of a second powder type can be applied to the powder bed by the wiper or the roller in order to create a powder mixture. The wiper or the roller then operate as a further dosing device. The powder mixture, whose mixing ratio can be affected by the quantity of the respective dosed powder, is thereby created. After the dosing, the steps of dosing powder of the first powder type by sprinkling and dosing powder of the second powder type by means of wiper or roller can be repeated one or a plurality of times. The mixing ratio of the two powder types depends on each case on the quantity of the individual powder types that are to be dosed. When sprinkling, the dosed powder quantity can be affected on the one hand by the opening cross-section of the dosing apparatus and on the other hand by the speed of movement during the sprinkling. The quantity of powder dosed through the further dosing apparatus is primarily to be influenced by the height above the surface of the powder bed this is guided.

The thickness of the layers to be generated in the powder bed depends not least on the processing parameters of the additive fabrication process applied. If the mixing ratio of the two powders requires, the dosing steps for the powder of the first powder type and the powder of the second powder type may have to be repeated multiple times until the required layer thickness for solidification by the energy beam (laser beam or electron beam) is achieved. Through repeated dosing it is thus possible for intermediate layers to be generated that together form the layer to be solidified in the powder bed. A finer distribution of the powder of the first powder type in the powder of the second powder type is in this way possible through sprinkling. Within a layer to be fabricated, a linear concentration gradient of the powder of the first powder type in the powder of the second powder type can moreover be generated.

Depending on the quantity of energy introduced for solidifying the powder and the melting points of the different powder types, an alloying of the powder types can be obtained during the manufacture of the contact component (variant 1), or the particles of the powder of the first powder type and the second powder type form a dispersion. The powder of the first powder type here is not melted (variant 2) and, through the melting of the powder of the second powder type, is distributed as a dispersion in a matrix of the material formed by the powder of the second powder type. There is, however, also a possibility that both powders melt, but do not form an alloy (variant 3). An emulsion is then formed, which solidifies again.

This would, for example, be the case with copper and molybdenum (with a sufficiently high energy input of the energy beam), which are not miscible and not soluble in one another (variant 3). Cu—Mo mixtures are in fact particularly interesting for contacts, since they combine a high resistance to wear with a good electrical conductivity. Powder mixtures of the first and second powder types with a powder proportion of from 20 to 80% of molybdenum by volume can be used here.

Silver and copper can be melted together with chromium, nickel, iron, titanium or zinc through the melting process created by the additive fabrication method, wherein alloys are created with the formation of mixed crystals (variant 1).

The powder of the first powder type can, however, also consist of tungsten, tantalum, niobium, molybdenum, rhenium, carbon, tin oxide (SnO₂), tungsten carbide (WC), cadmium oxide (CdO), zinc oxide (ZnO), iron oxide (Fe₂O₃), zirconium oxide (ZrO₂), magnesium oxide (MgO), nickel oxide (NiO) or indium oxide (In₂O₃). Because of the high melting temperatures, particles of this type of powder are not normally melted by the energy input of the energy beam (variant 2). CdO is molten above 1230° C. SnO2 has a melting point at 1630° C. Molybdenum melts at 2620° C. These temperatures are still within the reach of the beam melting process such as SLM, so that, depending on the power of the energy beam, melting of both powder types can result (variant 3). In both variants, the particles are incorporated while forming a dispersion in the matrix of the surrounding material of silver or copper.

If the powder of the first powder type and the powder of the second powder type are mixed in the layers, powder that is not solidified is left as waste comprising a powder mixture. This effect can largely be avoided if the powder of one powder type is only dosed locally into the region in which a solidification of the powder bed should take place.

The powder of the first powder type that has not solidified and of the second powder type can, however, be used as powder of the first type for subsequent fabrication steps of further contact components. This does require the mixing ratio to be known. This can either be determined metrologically or calculated from the powder consumption of the associated fabrication process of a component. In the subsequent fabrication process, the powder of the second powder type can then be added if it is necessary for achieving the required concentration. This does, obviously, require that the concentration of the powder of the second powder type in the powder used as the powder of the first powder type still lies below the concentration that is to be generated in the contact component.

In some embodiments, the contact component is manufactured through the additive generation of a contact layer on a ready-made contact carrier. This has the advantage that only the part of the contact component that forms the contact surface has to be manufactured additively using the additive fabrication method. The rest of the structure can thus be manufactured economically by means of conventional fabrication methods. The contact carrier can, for example, consist of a contact platelet, which can be stamped from metal sheet. Another possibility consists in that the contact component is fabricated as a contact layer directly on a contact head of the contact component.

In some embodiments, there is a contact component, a vacuum interrupter with such a contact component, or a switchgear with such a vacuum interrupter, wherein a contact component is manufactured according to the method described above. The advantages already indicated for the contact component manufactured in this way in connection with the methods described herein are achieved here.

In the exemplary embodiments, the components of the forms of embodiment that are described each represent single features of the teachings herein that are to be considered independently of one another, each of which also develops the teachings independently of one another, and are thus also to be considered individually, or in a combination other than that illustrated, as elements of the description. The forms of embodiment described can, moreover, also be extended through more of the features already described.

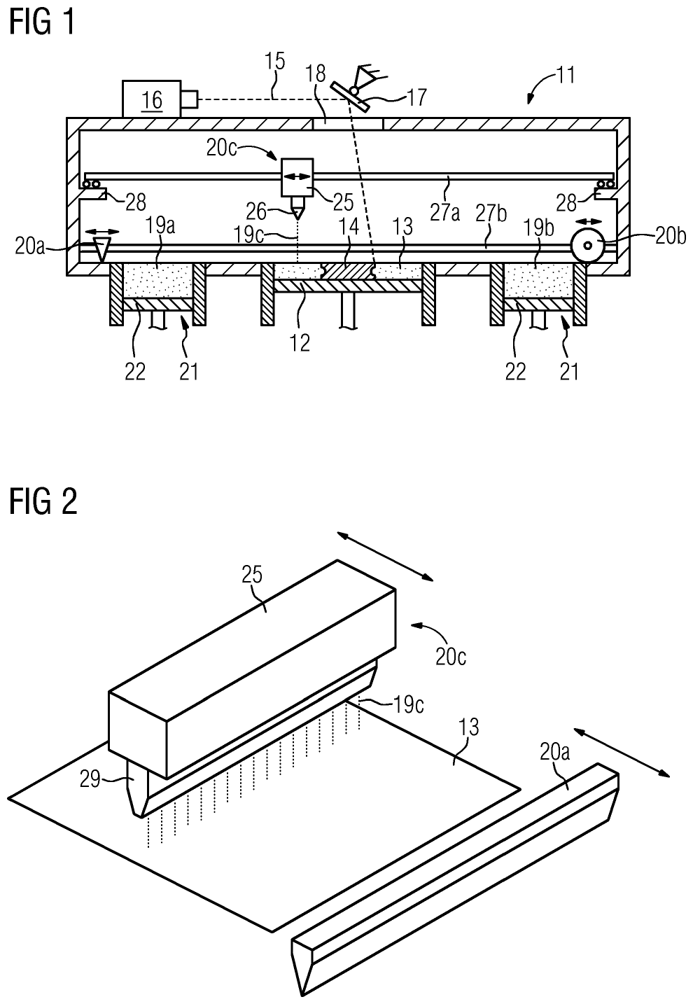

An example installation for laser melting is illustrated in FIG. 1. This comprises a process chamber 11 in which a construction platform 12 that can be lowered is provided for the creation of a powder bed 13. A contact platelet 123 coated with a contact layer 130 can be manufactured as a component 14 on the construction platform 12 in that an energy beam 15 in the form of a laser beam is generated by a laser 16 and directed onto the component 14 via a deflection mirror 17 through a window 18 in the process chamber 11.

The manufacture of the component 14 takes place in layers, wherein the construction platform 12 can be successively lowered for this purpose. A powder 19a and a powder 19b can be dosed for filling the powder bed 13 in layers by means of a wiper 20a that can be moved horizontally in the direction of the double arrow illustrated along a crossbar 27b. The powder 19a, 19b is contained for this purpose respectively in a powder store 21, while an axially movable dosing cylinder 22 determines the quantity of powder to be transported by the wiper 20a. A further powder can be contained in a powder store, not illustrated, located behind the plane of the drawing which can be dosed by a wiper, not illustrated, at right angles to the double arrow of the illustrated wiper 20a.

Both, for example, the powder 19a as well as, subsequently, the powder 19b can be dosed in a layer to be fabricated by means of the wiper 20a. When moved axially during the dosing of the powder 19b, the wiper here creates a powder mixture of the two powders 19a, 19b. With a dosing device implemented as a sprinkling device 20c, a powder 19c can be dosed by sprinkling onto the powder bed 13. The sprinkling device 20c comprises a reservoir container 25 to which a closable dosing hopper 26 is attached. The powder 19c can thereby be put down on the powder bed 13 selectively underneath the dosing hopper 26. In order to apply the powder 19c over regions with a larger area (partial or complete surface of the powder bed 13), the sprinkling device 20c is mounted in a movable manner on a crossbar 27a, wherein the crossbar 27a can itself be moved on rails 28 perpendicularly to the plane of the drawing. By means of motor drives, not illustrated, the sprinkling device 20c can thus be moved over the entire area of the powder bed 13.

The surface of the powder bed 13 can be smoothed by means of a roller 20b after the powder 19c has been dosed. This can be pushed on a crossbar 27b, so rolling over the powder bed 13. If the roller is used as the dosed apparatus, it is blocked so that rolling over the powder bed is prevented. Instead, the roller 20b then again accompanies the wiper 20a over the powder bed. The crossbar 27b serves as a guide for both the wiper 20a and for the roller 20b; a motor drive is not illustrated in more detail.

By using the dosing devices one after another, a mixture of powders can be formed on the powder bed 13; for example, the powder 19c of a first powder type, for example carbon, and a powder 19a of a second powder type, for example copper. Another powder 19b of a second powder type, consisting of silver, can also be used instead.

FIG. 2 illustrates that the sprinkling device 20c can also be fitted with a powder feed 29 instead of with a dosing hopper 26 (cf. FIG. 1) having a dosing slot, not illustrated in more detail. It is possible in this way for the powder 19c to be dosed in a shorter time, wherein the dosing slot corresponds to the width of the powder bed 13, measured perpendicularly to a direction of movement of the sprinkling device 20c suggested by a double arrow. The wiper 20a is also illustrated and can also be moved in the direction of the suggested double arrow, and serves in the exemplary embodiment according to FIG. 2 for smoothing the powder 19c that has been dosed by sprinkling.

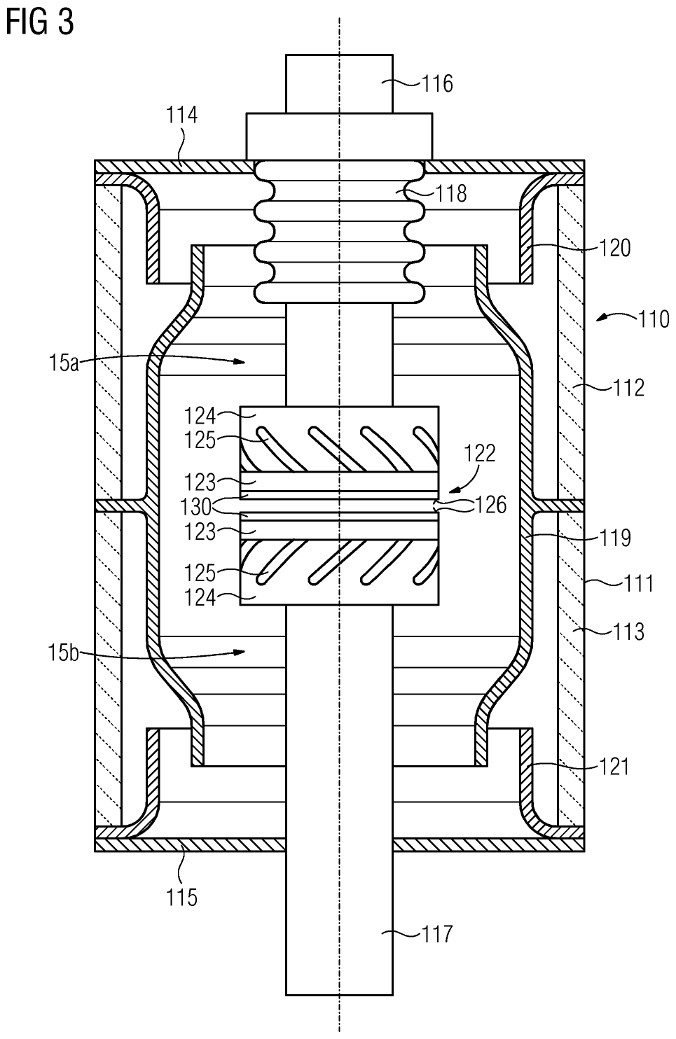

An example vacuum interrupter 110 as shown to FIG. 3 comprises an evacuated housing 111 that consists essentially of two coaxially arranged, hollow cylindrical ceramic insulators 112 and 113, and two covers 114 and 115. Current carrying bolts 116, 117 pass through the covers 114, 115 to a contact arrangement 122, (the current-carrying bolt 116 is made to be axially movable for the purpose of carrying out the switching process). A bellows 118 is also part of the housing and is soldered on the one side to the cover 115 and on the other side to the current-carrying bolt 116. A main screen 119 is arranged inside the housing, as well as an upper end screen 120 and a lower end screen 121 as screening elements.

Two contact components 15a, 15b are used in the vacuum interrupter 110. The contact component 15b is permanently connected to the housing 111 by the current-carrying bolt 117, so forming a permanent contact. The contact component 15a is implemented as a switch contact via the current-carrying bolt 116, which is axially movable. The end faces of the contact components 15a, 15b, which lie opposite one another, each have the contact layer 130 located in each case on a contact platelet 123 which in turn is soldered to the current-carrying bolt 116 or the current-carrying bolt 117. For this purpose, the current-carrying bolts 116, 117 each provide a contact head 124 having slots 125.

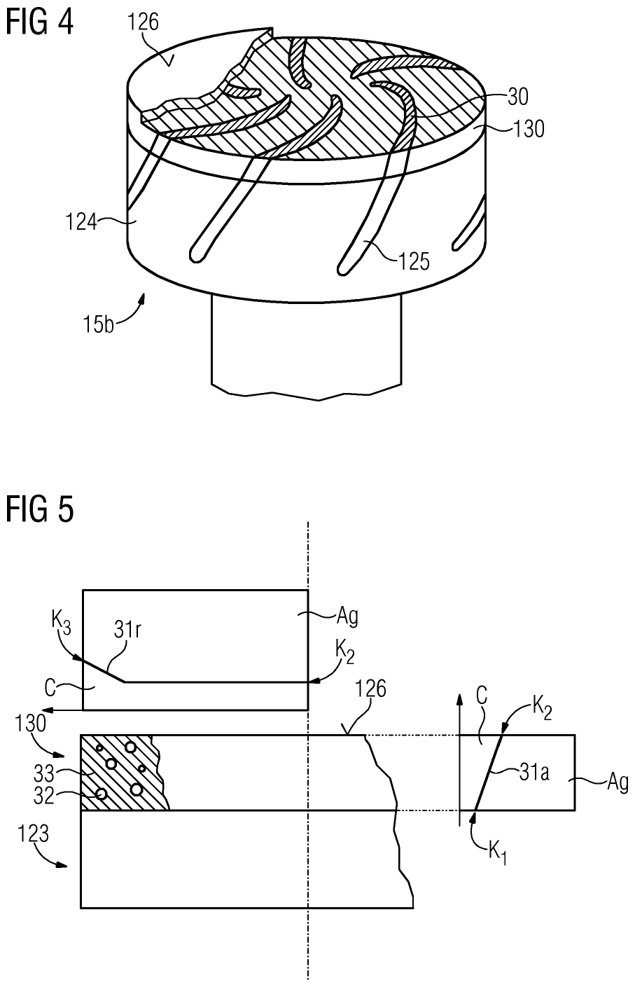

FIG. 4 illustrates a contact component 15b that is similar to that of FIG. 3. This differs from the contact component 15b according to FIG. 3, however, in that the contact layer 130 is not manufactured on a contact platelet (cf. FIG. 3, 123), but directly on the contact head 124. The contact layer 130 also comprises inset structures 30 which should influence the development of the magnetic field during the switching process, and thereby the propagation of the arc. The inset structures 30 here continue the geometry of the slots 125, with the difference that they are filled with the material of the powder of the first powder type. The inset structures 30, as well as, in a manner not illustrated, the slots 125 are curved in the radial direction.

As can also be seen in FIG. 4, the inset structures 30 are visible because the contact layer 130 is shown in a partially cutaway view. The cut lies horizontally in a plane in which the inset structures 30 end in the axial direction of the contact component 15, which means that the subsequent layers that constitute the contact surface 126 are manufactured without the inset structure 30. These layers are created by mixing the powder of the first powder type, for example silver, and powder of the second powder type, for example carbon, and subsequent solidification of the powder mixture. A constant mixing ratio of the two powders here develops in this region of the contact layer 130.

FIG. 5 illustrates how a concentration gradient 31a, 31r can be developed in the contact layer 130 by mixing the first powder type and the second powder type. The contact layer 130 is located on a contact platelet 123, as is used in the vacuum switch according to FIG. 3. The powder of the first powder type consists of carbon C, which is embedded as particles 32 in a matrix 33 of silver Ag. The dimensional relationships of FIG. 5 do not here correspond to reality. The matrix of silver is created by melting the powder of the second powder type, which consists of silver.

It can be seen that by mixing the two powder types the concentration of powder of the first powder type is continuously raised in the axial direction in sequential layers, so that the concentration of carbon rises from a concentration K₁ at the boundary surface between the contact platelet 123 and the contact layer 130 up to a concentration K₂ at the contact surface 126.

It is also at the same time possible for the concentration of the carbon to change locally within one layer. This is also illustrated in FIG. 5, wherein the concentration of carbon K₂ remains initially constant moving to the outside in the radial direction starting from the central axis of the contact layer 130. In the outer radial region, the concentration gradient 31r then results up to the outer edge of the contact layer, wherein the concentration K₃ develops at the edge. The concentration content K of carbon particles can be controlled in this way according to requirement. The exemplary embodiment according to FIG. 5 is here only explained by way of example. Other concentration distributions can be used according to requirement.

Additively manufactured contact layers of silver with embedded graphite particles, for example, exhibit outstanding electrical properties. On the one hand, the graphite particles reduce the speed with which the contact layer is worn away. On the other hand, a contact layer with sufficiently high electrical conductivity can be manufactured, only being lowered to a slight extent by the embedded graphite particles.

What is claimed is:

1. A method for manufacturing a contact component for an electrical switch with a contact surface for closing in electrical contact, the method comprising:
manufacturing the contact component is at least partially using a powder;
wherein at least two powder types are used to create different material compositions in the contact component;
wherein manufacturing the contact component include using an additive fabrication process based on a powder bed;
the contact component includes a sequence of layers; and
at least two of the layers include different powder types.

2. The method as claimed in claim 1, further comprising combining powders of different powder types by applying the powders with a plurality of dosing devices in at least one of the layers of the powder bed.

3. The method as claimed in claim 2, wherein a first one of the dosing devices comprises a sprinkling device guided at a distance above the surface of the powder bed.

4. The method as claimed in claim 3, further comprising, after dosing by sprinkling, smoothing a surface of the powder bed with a further dosing device including a wiper or a roller.

5. The method as claimed in claim 3, further comprising, after dosing the first powder type, dosing a second powder of a second powder type is dosed by a second dosing device.

6. The method as claimed in claim 1, wherein the powder is dosed only in a partial area of the powder bed by one of the dosing devices.

7. The method as claimed in claim 6, wherein:
the first powder type is dosed into a partial area of the layer of the powder bed;
at least a part of the first powder type is solidified by an energy source;
a second powder type is then dosed into the same layer; and
at least a part of the second powder type is solidified by the energy source.

8. The method as claimed in claim 6, wherein the first powder type includes at least one material chosen from the group consisting of: chromium, nickel, tungsten, iron, tantalum, niobium, molybdenum, rhenium, titanium, zinc, carbon, SnO2, WC, CdO, ZnO, Fe2O3, ZrO2, MgO, NiO, and In2O3; and
the second powder type comprises at least one of silver or copper.

9. The method as claimed in claim 6, further comprising creating an inset structure using the first powder type in a plurality of sequential layers; and
wherein the inset structure is embedded in the second powder type when it is solidified.

10. The method as claimed in claim 1, further comprising creating a powder mixture a layer of the powder bed including a first powder type and a second powder type.

11. The method as claimed in claim 10, wherein:
the first powder type comprises at least one material selected from the group consisting of:
chromium, nickel, tungsten, iron, tantalum, niobium, molybdenum, rhenium, titanium, zinc, carbon, SnO2, WC, CdO, ZnO, Fe2O3, ZrO2, MgO, NiO, and r In2O3;
the second powder type comprises at least one material selected from the group consisting of: silver, copper, and
a mixture of particles of silver or copper and particles of: chromium, nickel, tungsten, iron, tantalum, niobium, molybdenum, rhenium, titanium, zinc, carbon, SnO2, WC, CdO, ZnO, Fe2O3, ZrO2, MgO, NiO, or In2O3.

12. The method as claimed in claim 10, wherein a mixing ratio between the first powder type and the second powder type changes in a sequence of layers.

13. The method as claimed in claim 1, wherein the contact component is manufactured through the additive creation of a contact layer on a prefabricated contact carrier.

14-16. (canceled)
